(19) United States
(12) Patent Application Publication
(10) Pub. No.: US 2006/0141981 A1
(43) Pub. Date: Jun. 29, 2006

(54) Universal temporary communication ID with service integration

(75) Inventor: Jyh-Han Lin, Parkland, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/021,581

(22) Filed: Dec. 23, 2004

(51) Int. Cl. H04Q 7/20

(52) U.S. Cl. 455/403

(57) ABSTRACT

A method is provided for obtaining a temporary ID. A request is created for a temporary ID for a first user that has a permanent ID for being contacted through a first mode of communication. The request, which includes at least one usage rule provided by the first user, is sent to an ID generator. A temporary ID that allows a second user to contact the first user through the first mode of communication without knowing the permanent ID of the first user is received from the ID generator. The temporary ID is mapped to the permanent ID of the first user and is mapped with the at least one usage rule. The at least one usage rule limits use of the temporary ID to contact the first user through the first mode of communication. Akso provided are a method for providing a temporary ID and a method for using a temporary ID.

### FIELD OF THE INVENTION

The present invention generally relates to the field of telecommunications and more specifically to a universal temporary communication identification with service integration.

### BACKGROUND OF THE INVENTION

In many everyday encounters, situations arise in which it is necessary to give personal contact information to a third party. Personal contact information may include a phone number, email address, Instant Messenger (IM) ID, Voice over Internet Protocol (VoIP) ID, dispatch ID, etc. However, there are numerous instances where someone would be hesitant to deliver such information because of concerns about privacy, safety, telemarketing, spamming, or various other reasons.

In the past, a partial solution to this problem has been to acquire a temporary phone number for access by third parties which forwards telephone calls that are made to the temporary number to a primary number without having to reveal the primary number to the third party. However, this solution has very limited application considering the vast array of communication modes that exist today. For example, a single individual may have a traditional wired telephone number at home, another phone number for work, a fax number, a cellular phone number, a two-way device ID, a wirelessly enabled personal data assistant (PDA) ID, various email addresses, instant messaging ID's and any number of other IDs. The temporary telephone number is limited to only telephone use and provides no solution for a user's other forms of communication. Additionally, the total number of available phone numbers is limited by the telephone service, and additional numbers can be expensive to obtain for one-time or short-lived use.

Therefore, a need exists to overcome the problems with the prior art, as discussed above.

### SUMMARY OF THE INVENTION

Briefly, one embodiment of the present invention provides a method for obtaining a temporary ID. According to this exemplary method, a request is created for a temporary ID for a first user that has a permanent ID for being contacted through a first mode of communication. The request, which includes at least one usage rule provided by the first user, is sent to an ID generator. A temporary ID that allows a second user to contact the first user through the first mode of communication without knowing the permanent ID of the first user is received from the ID generator. The temporary ID is mapped to the permanent ID of the first user and is mapped with the at least one usage rule. The at least one usage rule limits use of the temporary ID to contact the first user through the first mode of communication.

Another embodiment of the present invention provides a method for providing a temporary ID. According to this exemplary method, a request for a temporary ID is received from a first user that has a permanent ID for being contacted through a first mode of communication, with the request including at least one usage rule provided by the first user. The temporary ID is generated and mapped to the permanent ID of the first user so as to allow a second user to contact the first user through the first mode of communication without knowing the permanent ID of the first user. The temporary ID is also with the at least one usage rule so as to limit use of the temporary ID to contact the first user through the first mode of communication. The temporary ID is sent to the first user.

Yet another embodiment of the present invention provides a method for using a temporary ID. According to this exemplary method, a communication directed to a temporary ID of a first user is received from a second user through a first mode of communication. A permanent ID of the first user is determined through a mapping with the temporary ID of the first user, and at least one usage rule that is also mapped with the temporary ID is evaluated in order to determine if the second user is permitted to use the temporary ID to contact the first user through the first mode of communication at this time. I it is determined that contact is permitted, the communication is forwarded through the first mode of communication to the permanent ID of the first user.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a short-lived ID system in accordance with one embodiment of the present invention;

FIG. 2 is a detailed block diagram depicting a wireless device of the short-lived ID system of FIG. 1 according to one embodiment of the present invention;

FIG. 3 is a detailed block diagram of the short-lived ID server of FIG. 1 according to an embodiment of the present invention;

FIG. 4 is a detailed block diagram of the short-lived ID client application of FIG. 2 according to an embodiment of the present invention;

FIG. 5 is an operational flow diagram illustrating an operational sequence for requesting a short-lived ID according to an embodiment of the present invention;

FIG. 6 is an operational flow diagram illustrating an operational sequence for issuing a short-lived ID according to an embodiment of the present invention;

FIG. 7 is an information flow diagram illustrating an integrated process for requesting and receiving a short-lived ID according to an embodiment of the present invention;

FIG. 8 is an operational flow diagram illustrating an operational sequence for requesting a revocation of a short-lived ID according to an embodiment of the present invention;

FIG. 9 is an operational flow diagram illustrating an operational sequence for revoking a short-lived ID according to an embodiment of the present invention;

FIG. 10 is an information flow diagram illustrating an integrated process for requesting a revocation and revoking a short-lived ID according to an embodiment of the present invention; and

FIG. 11 is a block diagram illustrating exemplary modes of use for a short-lived ID according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

While the specification concludes with claims defining the features of the invention that are regarded as novel, it is believed that the invention will be better understood from a consideration of the following description in conjunction with the drawing figures, in which like reference numerals are carried forward.

The present invention overcomes problems with the prior art by creating a temporary, short-lived, general purpose ID at the user's request. (The terms “temporary ID” and “short-lived ID” are used interchangeably throughout this document in reference to the temporary, short-lived ID of the present invention.) The short-lived ID may be subject to usage rules and easily revoked at the user's request or under preset conditions such as expiring after a predetermined time or the occurrence of an event. The short-lived ID may be given to third parties that wish to contact the user, without compromising the integrity of the user's permanent identification mechanisms (i.e., phone numbers, email addresses, instant messaging IDs, etc.) This short-lived ID can be used in conjunction with a large variety of communication tools, applications, and devices such as telephones, wireless phones and radios, personal data assistants (PDAs), fax machines, instant messaging (IM) systems, email systems, telecom switching services, voice-over-IP (Voip) clients, electronic phone books, etc.

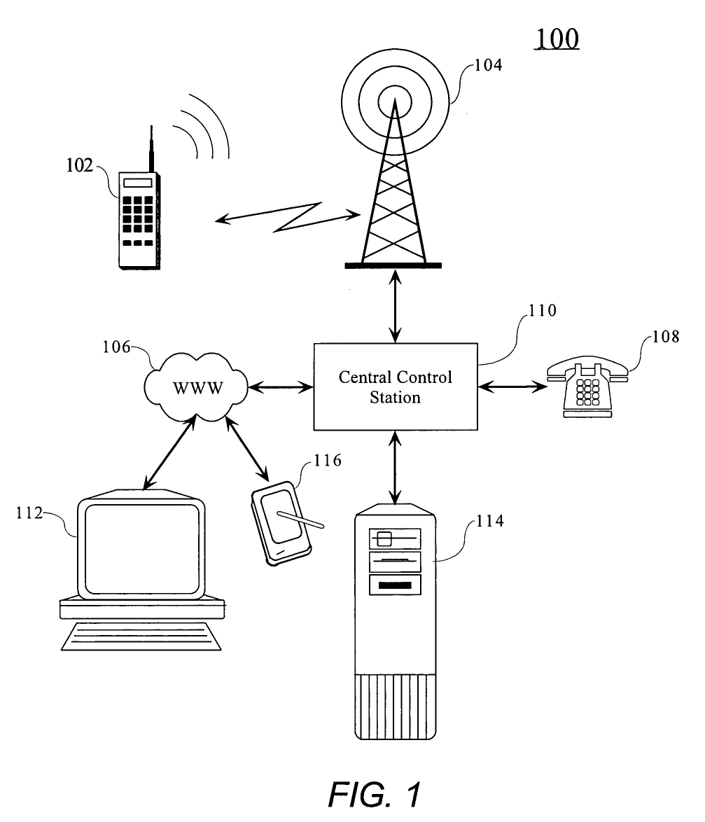

FIG. 1 illustrates a short-lived ID communication system 100 in accordance with one embodiment of the present invention. The exemplary system includes at least one wireless mobile subscriber device (or wireless device) 102, operating within range of a cellular base station 104. The cellular base station 104 communicates with other devices, such as wired telephones 108 or other wireless devices through a central control station 110. The central control station 110 communicates directly with a short-lived ID server 114 and with devices such as computers 112 and PDAs 116 by way of the Internet 106 (also known as the world-wide web). Alternatively, the central control station 110 can also communicate with the short-lived ID server 114 through the Internet 106.

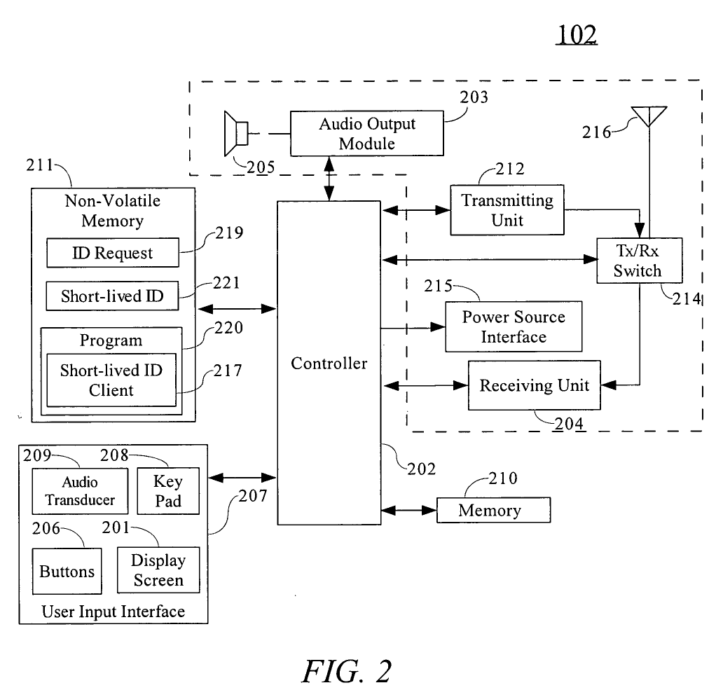

Referring to FIG. 2, a wireless device 102 in accordance with one embodiment of the present invention is shown in more detail. (The terms “electronic device”, “phone”, “cell phone”, “radio”, and “wireless device” are used interchangeably throughout this document in reference to an exemplary electronic device.) The wireless device 102 of the exemplary short-lived ID communication system 100 includes a keypad 208, other physical buttons 206, a display screen 201, and an audio transducer 209 such as in a microphone to receive and convert audio signals to electronic audio signals for processing in the electronic device 102 in a well known manner, all of which are part of a user input interface 207. The user input interface 207 is communicatively coupled with a controller 202. The electronic device 102, according to this embodiment, also comprises a memory 210; a non-volatile memory 211 containing at least a program memory 220 (which includes a short-lived ID client application 217), a short-lived ID 221, and an ID request 219; and a power source interface 215. The short-lived ID client application 217, which allows a user to define rules for using a short-lived ID 221, request the short-lived ID 221, and also revoke the short-lived ID 221, is discussed in more detail below. Although the present embodiment describes the short-lived ID client application 217 as residing on a wireless device 102, this application could alternatively reside on a computer 112, PDA 116, or any other device that would permit a user to communicate with the short-lived ID server 114.

The electronic device 102, according to this embodiment, comprises a wireless communication device 102, such as a cellular phone, a portable radio, a PDA equipped with a wireless modem, or other such type of wireless device. The wireless communication device 102 transmits and receives signals for enabling a wireless communication such as for a cellular telephone, in a well known manner. For example, when the wireless communication device 102 is in a “receive” mode, the controller 202 controls a radio frequency (RF) transmit/receive switch 214 that couples an RF signal from an antenna 216 through the RF transmit/receive (TX/RX) switch 214 to an RF receiver 204, in a well known manner. The RF receiver 204 receives, converts, and demodulates the RF signal, and then provides a baseband signal to an audio output module 203 and a transducer 205, such as a speaker, to output received audio. In this way, for example, received audio can be provided to a user of the wireless device 102. A receive operational sequence is normally under control of the controller 202 operating in accordance with computer instructions stored in the program memory 220, in a well known manner.

In a “transmit” mode, the controller 202, for example responding to a detection of a user input (such as a user pressing a button or switch on the keypad 208), controls the audio circuits and couples electronic audio signals from the audio transducer 209 of a microphone interface to transmitter circuits 212. The controller 202 also controls the transmitter circuits 212 and the RF transmit/receive switch 214 to turn ON the transmitter function of the electronic device 102. The electronic audio signals are modulated onto an RF signal and coupled to the antenna 216 through the RF TX/RX switch 214 to transmit a modulated RF signal into the wireless communication system 100. This transmit operation enables the user of the device 102 to transmit, for example, audio communication into the wireless communication system 100 in a well known manner. The controller 202 operates the RF transmitter 212, RF receiver 204, the RF TX/RX switch 214, and the associated audio circuits according to computer instructions stored in the program memory 220.

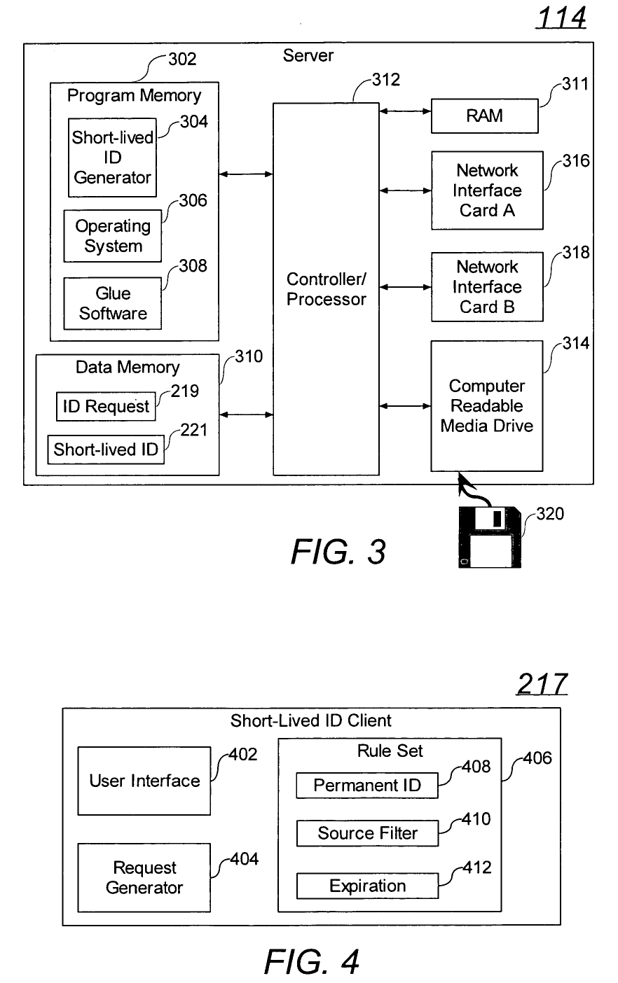

A more detailed block diagram of a short-lived ID server 114 according to a preferred embodiment of the present invention is shown in FIG. 3. The server 114 includes one or more processors 312 which process instructions, perform calculations, and manage the flow of information through the server 114. The server 1 14 also includes a program memory 302, a data memory 310, and random access memory (RAM) 311. Additionally, the processor 312 is communicatively coupled with a computer readable media drive 314, network interface cards (NIC) 316 and 318, and the program memory 302. The network interface cards 316 and 318 may be wired or wireless interfaces.

Included within the program memory 302 are a short-lived ID generator 304, operating system platform 306, and glue software 308. The operating system platform 306 manages resources, such as the information stored in data memory 310 and RAM 311, the scheduling of tasks, and processes the operation of the short-lived ID generator 304 in the program memory 302. Additionally, the operating system platform 306 also manages many other basic tasks of the server 114 in a well-known manner.

Glue software 308 may include drivers, stacks, and low-level application programming interfaces (API's); it provides basic functional components for use by the operating system platform 306 and by compatible applications that run on the operating system platform 306 for managing communications with resources and processes in the server 114.

Various software embodiments are described in terms of this exemplary computer system. After reading this description, it will become apparent to a person of ordinary skill in the relevant art(s) how to implement embodiments of the present invention using any other computer systems and/or computer architectures.

In this document, the terms “computer program medium,” “computer-usable medium,” “machine-readable medium” and “computer-readable medium” are used to generally refer to media such as program memory 302 and data memory 310, removable storage drive, a hard disk installed in hard disk drive, and signals. These computer program products are means for providing software to the server 114. The computer-readable medium 320 allows the server 114 to read data, instructions, messages or message packets, and other computer-readable information from the computer-readable medium 320. The computer-readable medium 320, for example, may include non-volatile memory, such as Floppy, ROM, Flash memory, disk drive memory, CD-ROM, and other permanent storage. It is useful, for example, for transporting information, such as data and computer instructions, between computer systems. Furthermore, the computer-readable medium 320 may comprise computer-readable information in a transitory state medium such as a network link and/or a network interface, including a wired network or a wireless network, that allow a computer to read such computer-readable information.

One exemplary embodiment of the present invention integrates the exemplary short-lived ID client application 217 shown in FIG. 4, which is implemented through the wireless device 102 with a remotely located ID server 114. Alternately, the ID client application 217 can reside on a computer or PDA or can be remotely accessed, such as through a web site by way of a computer, PDA, or mobile phone browser. During operation, a user requests a short-lived communication ID through a user-interface 402 of the client application 217. The user also provides a set of rules 406 which governs the way the short-lived ID operates, including the permanent ID 408 (or IDs) to be associated with the short-lived ID. The set of rules 406 also includes information such as the expiration rules 412 and a source filter 410 which specifies any restrictions associated with the source. The expiration rules 412 can be based, for example, on the number of uses, the time to live, time of expiration, or any other such criteria. The expiration rules 412 can optionally be set up as default rules for a particular user or group account. When the short-lived ID expires, its association with the permanent ID is discarded. Restrictions identified at the source filter 410 include, for example, limiting the use of the short-lived ID to one or more specific callers and senders, including other short-lived IDs and limiting the access to the short-lived ID to one or more specific modes of communication (e.g., limiting access only to email communications). A situation that exemplifies the use of the source filter 410 is the case where a user is expecting an email from a particular vendor. The user need specify only the email address of that vendor for the source filter 410. Any other emails targeting the short-lived ID will be rejected. The request generator 404 uses the set of rules 406 provided by the user to create a short-lived ID request.

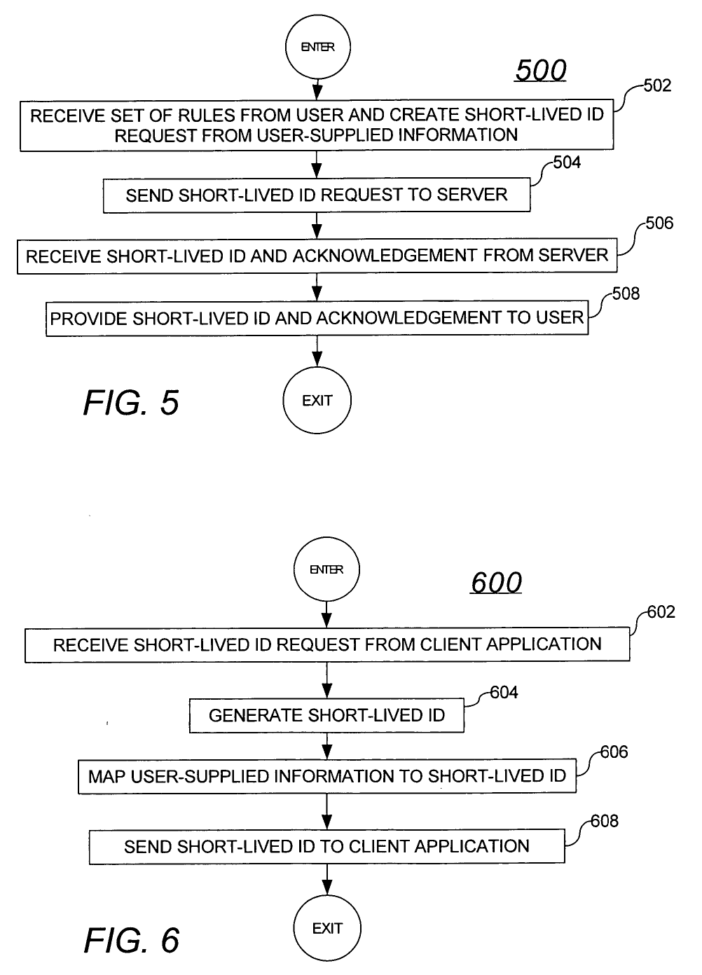

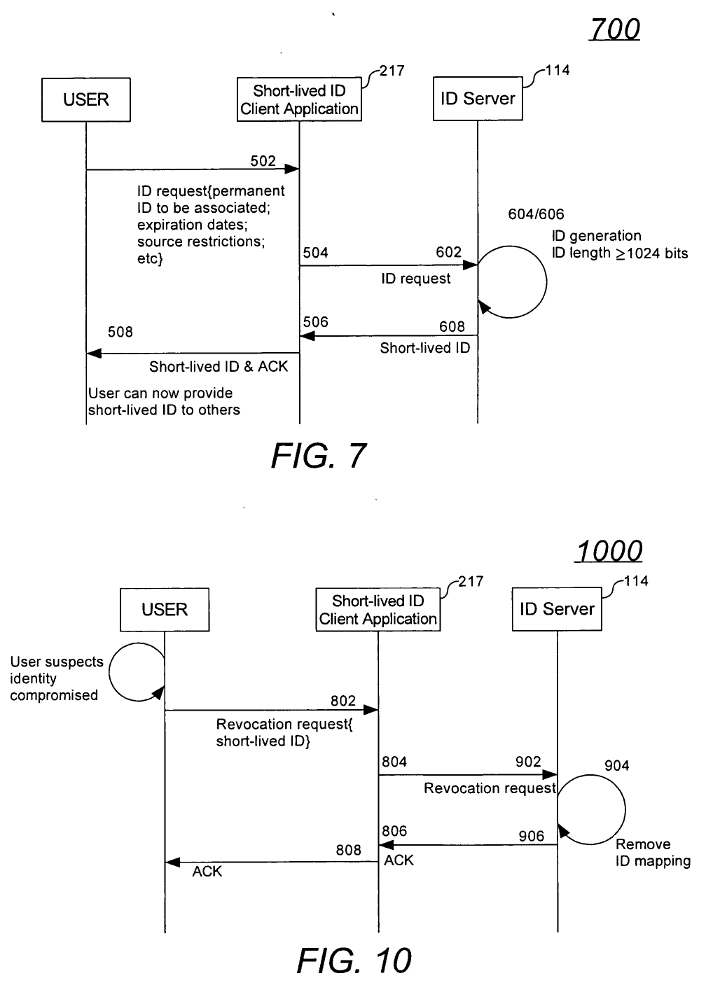

An exemplary operational sequence for generating a short-lived ID is illustrated in FIGS. 5, 6, and 7. FIG. 5 depicts the operation of the short-lived ID client application 217 according to an embodiment of the present invention; FIG. 6 shows the operation of the short-lived ID server 114 according to an embodiment of the present invention; and FIG. 7 illustrates the integration and sequence of operation of the system, including the role of a user, the client application 217, and the server 114 according to an embodiment of the present invention.

From the point of view of the client application 217, shown in FIG. 5, the method 500 begins when the request generator 504 of the client application 217 receives a set of rules 406 from the user, at step 502, and creates a short-lived ID request 219 from this user-supplied information. Next, the client application 217 sends the short-lived ID request 219 to the server 114, at step 504. After the server has processed the ID request 219, the client application 217 receives the short-lived ID 221 and an acknowledgement message from the server 114, at step 506. At step 508, the client application 217 provides the short-lived ID 221 and an acknowledgement message to the user through the user interface 402. These acknowledgement messages are used to confirm the short-lived ID and also contain further information, such as information that allows the server to confirm the rules specified by the user. Thus, for example, if the expiration date has already passed, this exchange allows an error message to be transmitted to start further error handling routines.

Turning now to FIG. 6, from the point of view of the server 114, the method 600 begins, at step 602, when the server 114 receives a short-lived ID request 602 from a client application 217. The ID request 602 contains all the user-provided rules 406 concerning expiration, source restrictions, and the permanent ID(s) to be associated with the short-lived ID 221. A short-lived ID generator 304 on the server 114 creates a short-lived ID 221, at step 604, and maps the data provided by the user to the short-lived ID 221 at step 606. Any reliable method can be used to generate a unique short-lived ID 221. For example, in one embodiment a public key generation algorithm uses a random number source for generating a unique key (short-lived ID) with extremely high probability. However, further embodiments can use simpler generation methods, such as a counter, to generate short-lived IDs. In other embodiments, globally-unique short-lived IDs are generated across different systems, such as by combining a time stamp and information that is unique to the server or system generating the ID (such as server location, IP address, or domain name). To avoid collision, the ID length is preferably greater than 1024 bits. At step 608, the server 114 sends the short-lived ID 221 and an acknowledgment to the client application 217.

The above-described methods utilize several distinct data structures, such as a short-lived ID data structure; an expiration rules data structure {number of uses, time-to-live, expiration time, . . . }; a source filter data structure {source1, source2, . . . }; and an associated permanent communication ID data structure {phone number, dispatch ID, email address, IM address, VoIP ID, Group ID, . . . }.

FIG. 7 illustrates the integration of the entire process of requesting a short-lived ID 221. To summarize, the user, at step 502, enters a set of rules 406 for the creation of a short-lived ID 221 at a client application 217, and the client application 217 creates an ID request 219. The client application 217 sends the ID request 219 to the server 114, at step 504. The server 114 receives the ID request 219 at step 602, creates the short-lived ID 221 at step 604, maps the user-supplied information to the short-lived ID 221 at step 606, and sends the short-lived ID 221 and an acknowledgement back to the client application 217 at step 608. The client application 217 receives the short-lived ID 221 and the acknowledgement at step 506, and provides them to the user at step 508. A user may now provide the short-lived ID 221 to others for contact purposes without fear of having identity compromised or permanent contact information disclosed.

Optionally, the server 114 may provide authentication service during the usage of the short-lived ID 221 for the identification of the owner of the short-lived ID 221. The authentication service provides assurance to the sender or caller using the short-lived ID 221 that the party receiving the communication is who they claim to be. This authentication verifies the source of the short-lived ID and provides additional security to ensure that the short-lived ID has not been compromised.

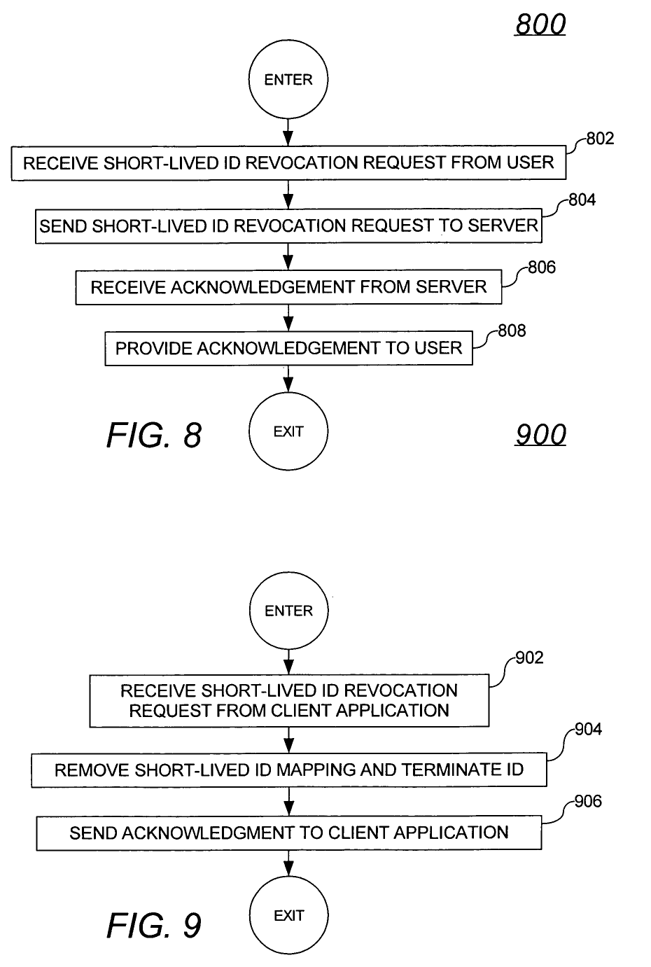

An exemplary embodiment of the present invention offers the ability to revoke the short-lived ID 221 by the service provider or at the user's request. If, for example, the user or service provider becomes concerned that the identity of the short-lived ID 221 has been comprised, the ID 221 can be terminated. FIGS. 8, 9, and 10 illustrate a sequence for revoking the short-lived ID 221 according to one embodiment of the present invention. As above, beginning from the point of view of the client application 217, in FIG. 8, the client application receives a short-lived ID revocation request from the user, at step 802. The client application 217 sends the revocation request to the server 114, at step 804. After the server 114 processes the revocation request, the client application 217 receives an acknowledgement from the server 114, at step 806, and provides this acknowledgement to the user, at step 808.

From the point of view of the server 114, as shown in FIG. 9, the server 114 receives a short-lived ID revocation request from the client application 217, at step 902. The server 114 removes the short-lived ID mapping and terminates the short-lived ID 221, at step 904. Finally, at step 906, the server 114 sends an acknowledgment to the client application 217 that the short-lived ID has been revoked.

FIG. 10 illustrates the integration of the entire process of revoking a short-lived ID 221. A user or service provider, suspecting that the identity of a short-lived ID 221 has been compromised or knowing that it is no longer needed, enters a request for revocation at a client application 217, at step 802. The client application 217 sends a revocation request, at step 804, to the short-lived ID server 114. The server 114 receives the revocation request at step 902, and removes the ID mapping, terminating the short-lived ID 221 at step 904. The server 114 sends an acknowledgement of the revocation to the client application 217 at step 906. The client application 217 receives the acknowledgement at step 806, and provides it to the user at step 808.

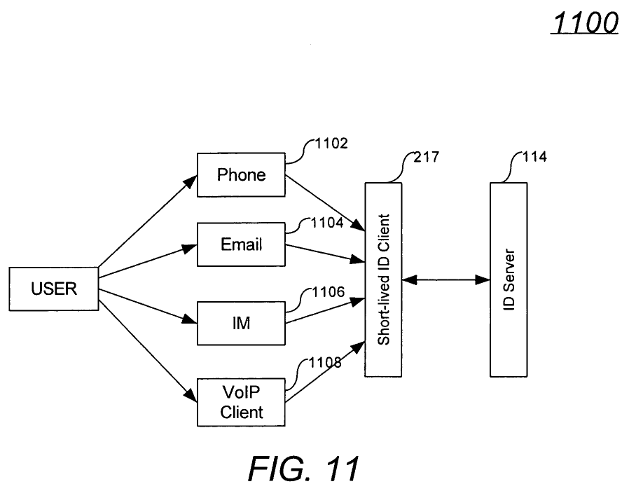

FIG. 11 illustrates exemplary modes of use for a short-lived ID. The user communicates with a short-lived ID client application 217, which, in turn, communicates with the ID server 114. Access to the short-lived ID client application 217 can occur via a telephone 1102 (or computer integrated phone), an e-mail system 1104, an IM system 1106, or a VoIP client 1108. For telephone communication 1102, the caller can use any telephone or telephone-like interface to dial a given number, such as an 1-800 or 1-900 number, to access the short-lived ID client application 217. This telephone number is the same for multiple short-lived IDs, such as all short-lived IDs provided by a given service provider. After a telephone connection with the short-lived ID client application 217 is established, the user simply enters (e.g., through dialing or speech) the short-lived ID of the person they are trying to reach. In response, the short-lived ID client application 217 accesses to the ID server 114 to obtain the corresponding permanent ID (i.e., actual telephone number), and uses this permanent ID to establish a telephone communication session between the user and the person associated with the permanent ID. For communication via the VoIP client 1108, the process can be the same or very similar with the calls being routed via IP addresses instead of phone numbers.

For email or IM communication 1104 or 1106, the user sends an email or IM message addressed to the short-lived ID at the ID service provider (e.g., short-lived-ID@ID-service-provider). Standard routing procedures cause such an email or IM to be received by the short-lived ID client application 217 of the ID service provider. In response, the short-lived ID client application 217 accesses to the ID server 114 to obtain the corresponding permanent ID (i.e., actual email or IM address), and uses this permanent ID to forward part or all of the email or IM received from the user to the person associated with the permanent ID. In some embodiments, the short-lived ID client application 217 can also be used to route return communications from the permanent ID back to the user with the short-lived ID substituted for the permanent ID. Thus, bi-directional email or IM communication can occur using the short-lived ID so as to keep private the permanent ID.

In all cases, the short-lived ID client application 217 checks the associated source filter requirements, expiration rules, and any other usage rules to verify that the user's communication meets the pre-determined conditions for using the short-lived ID. If so, the short-lived ID client application 217 establishes communication with or routes the message to the user as described above. An error indicator is sent to the caller if the source filter requirement or some other usage requirement is not satisfied or the short-lived ID has expired or been revoked.

The short-lived ID of the present invention allows the user to give only the short-lived ID to an expected caller or source. This is advantageously, for example, when ordering goods or services over the phone or online. The use of the short-lived ID for an online purchase prevents unwanted future email or spam communications to the permanent ID because the permanent email address is not disclosed to the provider. The short-lived ID can also allows a user to safely chat with strangers met online (such as in a chat room or through an online dating service) or in public (such as at a bar or club). Rather than giving a permanent telephone number or email address to the stranger, the user can simply give the short-lived ID can jeep the permanent ID private. Thus, the user can be secure in the knowledge that the permanent contact information is private until such time, if ever, that the user chooses to reveal the permanent number or email address. Also, the user can revoke the short-lived ID at any time to cut off communication with the stranger.

In one embodiment, short-lived IDs are marketed and billed similarly to current caller ID services. In an alternative embodiment, short-lived IDs are charged for on a flat fee (e.g., monthly) or per use basis.

The short-lived ID of embodiments of the present invention provides great advantages to a user. For example, the short-lived ID can be accessed from and integrated into a variety of existing telecom services including phone book applications, email clients, IM clients, VoIP clients, telecom switching services, and so on. Further, embodiments of the present invention allow the user to: 1) generate a new short-lived ID quickly when needed, 2) generate multiple short-lived IDs, each having a different purpose or usage rules, and 3) select usage rules for the newly generated short-lived ID. The user can specify that the short-lived ID only last for a certain duration or number of uses, or link it to one or more sources so that it only works when called from a certain number. Furthermore, the same short-lived ID can be used to contact the user via alternative modes such as telephone, email and instant messaging subject to the same or similar rules.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows a computer to read data, instructions, messages or message packets, and other computer readable information. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method comprising the steps of:
creating a request for a temporary ID for a first user that has a permanent ID for being contacted through a first mode of communication, the request including at least one usage rule provided by the first user;
sending the request to an ID generator; and
receiving from the ID generator a temporary ID that allows a second user to contact the first user through the first mode of communication without knowing the permanent ID of the first user, the temporary ID being mapped to the permanent ID of the first user and being mapped with the at least one usage rule,
wherein the at least one usage rule limits use of the temporary ID to contact the first user through the first mode of communication.

2. The method of claim 1,
wherein the first user has a second permanent ID for being contacted through a second mode of communication, and
the temporary ID is also mapped to the second permanent ID of the first user so as to allow the second user to contact the first user through the second mode of communication without knowing the second permanent ID of the first user.

3. The method of claim 2, wherein the permanent ID is an email address, and the second permanent ID is one of a telephone number and a VoIP ID.

4. The method of claim 1, wherein the at least one usage rule comprises a source filter that limits who can use the temporary ID to contact the first user.

5. The method of claim 1, wherein the at least one usage rule comprises an expiration rule that prevents use of the temporary ID to contact the first user after at least one of a set number of uses and an expiration time.

6. The method of claim 1, further comprising the step of sending a request to revoke the temporary ID so that the second user can no longer contact the first user through the first mode of communication using the temporary ID.

7. A method comprising the steps of:
receiving a request for a temporary ID from a first user that has a permanent ID for being contacted through a first mode of communication, the request including at least one usage rule provided by the first user;
generating the temporary ID;
mapping the temporary ID to the permanent ID of the first user so as to allow a second user to contact the first user through the first mode of communication without knowing the permanent ID of the first user,
mapping the temporary ID with the at least one usage rule so as to limit use of the temporary ID to contact the first user through the first mode of communication; and
sending the temporary ID to the first user.

8. The method of claim 7,
wherein the first user has a second permanent ID for being contacted through a second mode of communication, and
the method further comprises the step of mapping the temporary ID to the second permanent ID of the first user so as to allow the second user to contact the first user through the second mode of communication without knowing the second permanent ID of the first user.

9. The method of claim 8, wherein the permanent ID is an email address, and the second permanent ID is one of a telephone number and a VoIP ID.

10. The method of claim 7, wherein the at least one usage rule comprises a source filter that limits who can use the temporary ID to contact the first user.

11. The method of claim 7, wherein the at least one usage rule comprises an expiration rule that prevents use of the temporary ID to contact the first user after at least one of a set number of uses and an expiration time.

12. The method of claim 7, further comprising the steps of:
receiving a request to revoke the temporary ID from the first user; and
removing the mapping between the temporary ID and the permanent ID of the first user so that the second user can no longer contact the first user through the first mode of communication using the temporary ID.

13. A method comprising the steps of:
receiving a communication from a second user through a first mode of communication, the communication being directed to a temporary ID of a first user;
determining a permanent ID of the first user that is mapped with the temporary ID of the first user;
evaluating at least one usage rule that is mapped with the temporary ID of the first user in order to determine if the second user is permitted to use the temporary ID to contact the first user through the first mode of communication at this time; and
if it is determined that contact is permitted, forwarding the communication through the first mode of communication to the permanent ID of the first user.

14. The method of claim 13, further comprising the steps of:
receiving a second communication from the second user through a second mode of communication, the communication being directed to the temporary ID of the first user;
determining a second permanent ID of the first user that is mapped with the temporary ID of the first user;
evaluating at least one usage rule that is mapped with the temporary ID of the first user in order to determine if the second user is permitted to use the temporary ID to contact the first user through the second mode of communication at this time; and
if it is determined that contact is permitted, forwarding the communication through the second mode of communication to the permanent ID of the first user.

15. The method of claim 14, wherein the permanent ID is an email address, and the second permanent ID is one of a telephone number and a VoIP ID.

16. The method of claim 13, wherein the at least one usage rule comprises a source filter.

17. The method of claim 16, wherein the source filter prevents anyone other than the second user from using the temporary ID to contact the first user.

18. The method of claim 13, wherein the at least one usage rule comprises an expiration rule.

19. The method of claim 18, wherein the expiration rule prevents use of the temporary ID to contact the first user after at least one of a set number of uses or an expiration time.
